(19) United States
(12) Patent Application Publication
(10) Pub. No.: US 2005/0090291 A1
(43) Pub. Date: Apr. 28, 2005

(54) Alerting method for a wireless communication device

(75) Inventor: Stanford C. Stolzenthaler III, Baton Rouge, LA (US)

Correspondence Address: Mr, Stanford C. Stolzenthaler III, 5911 Willow Glen Dr., Baton Rouge, LA, 70809, US

(73) Assignee: Stanford C. Stolzenthaler III, Baton Rouge, LA (US)

(21) Appl. No.: 10/692,486

(22) Filed: Oct. 27, 2003

(51) Int. Cl. H04B 1/38

(52) U.S. Cl. 455/567

(57) ABSTRACT

An alerting method which will amplify and broadcast the notification signal produced by a wireless communication device, or use a notification signal produced by the invention. The invention will signal an incoming message or a missed message by amplification of the audio or visual signal generated by the wireless communication apparatus, or audio or visual signals generated by the invention itself. The invention may also charge the power source contained in the wireless apparatus and/or power the wireless apparatus. The device may also serve as a microphone and speaker attachment to the wireless communication apparatus.

### BACKGROUD OF THE INVENTION

1. Field of the Invention

The present invention relates to a communication device such as a wireless phone, portable computer, handle held or portable communication device, and in particular, to an alerting method and apparatus for alerting a user by sound, light or display to signal a message arrival to the communication device.

Mobil communication devices use various methods to produce a signal of incoming message. Some may produce a sound signal, vibrate or use visual means to notify the user. As the communication devices have achieved widespread use, and have become important for many as their primary communication method of communication. Therefore the importance of being aware of incoming messages from their mobile communication devices has increased and the production a signal which will notify the user who is not in close proximity to the communication device is necessary.

### SUMMARY OF THE INVENTION

The present invention is to provide an alerting method for a communication device which will generate a notification by audio or visual signal, which can be heard or seen from greater distance or for a longer duration of time than the alerting signal generated by the communication device.

Another objective of the present invention is to provide power to both recharge the internal power supply of the communication device and also power the communication device while it is attached to the invention. The invention will either be powered by an external power supply such as AC or DC current or by internal battery.

The invention will alter these power sources to the proper voltage and amperage need by the attached communication device.

The invention will receive the incoming message signal from the communication device by one of the following methods: (a) A microphone attached to the invention will receive the signal from the communication device for the invention; or (b) the communication device can be directly attached to the invention by a plug, pin wire, contact connection, optical connection, or non-contact low-power signal connection or other method to make a “attachment” to the invention, or any other type of contact between the communication device and the invention.

The invention will be signaled by the communication device a message is incoming. This signal will be amplified by the invention and then broadcast by the invention by the method or methods chosen by the user either audio, visual or both. The signal generated by the invention may be the same as the communication device, or a different signal produced by the invention. The invention may also repeat the broadcast of the signal, at a predetermined rate, after the communication device has ceased its signal.

The invention will have a signal light which will alert of a message. This light either may stay on or flash until the message of the communication device has been answered.

The invention may also have a display which will either display information generated by the communication device, or a message generated by the invention. The invention will contain a switch to terminate the audio and/or visual signal of the invention.

The invention will have a signal light to indicate the communication device is properly attached to the invention.

The invention will signal by light when the communication device is being charged by the invention and also when the communication device is full charged and the charging has ceased.

### BRIEF DESCRIPTION OF THE DRAWING

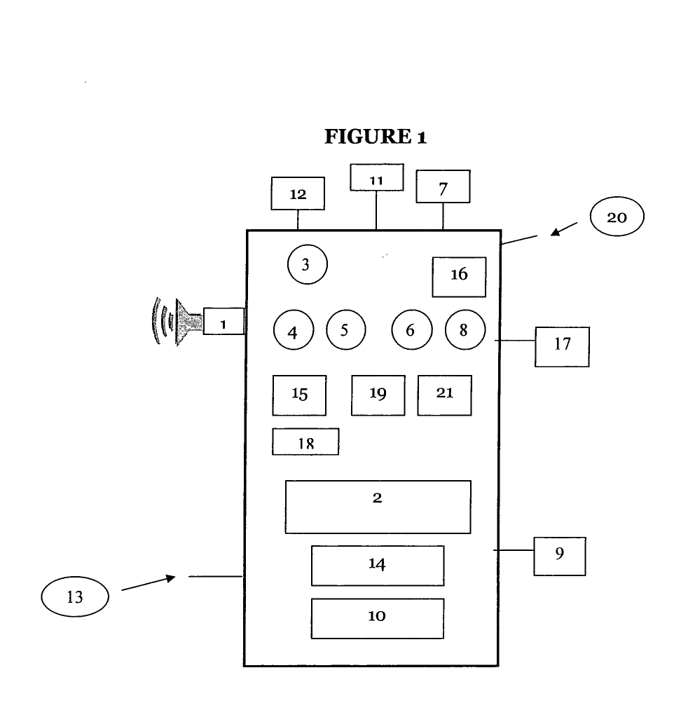

With reference now the drawing of a new method of indication of incoming message on a mobile communication device. More specifically, referring to FIG. 1, it will be noted that the first embodiment 20 of the invention includes a housing. A connection 13 to an outside power source such as AC or DC current connects to a transformer 14 which will power both the invention and charge the communication device. A battery 10 may also be attached to the transformer to power either the invention or communication device. The battery may be either disposable or rechargeable. A controller 16 will stop charging the communication device when its power source is fully charged. A light 15 will indicate when the invention has power. A light 4 will signal when the communication device is properly attached to the invention and is being powered by the invention or charging its power source. A light 5 will indicate the communication device is charging. The communication device will be docked 11 to the invention to transfer a signal to indicate an incoming message to the invention. The communication device will also be attached 12 to the invention to transfer power to the communication device. A microphone 7 will also be attached to the invention this shall be used to receive an audio signal generated from the communication device if the communication device is not able to connect to the invention to transfer a signal indicating a message. The signal from the microphone or the signal directly from the communication device will go to amplifier 17 which will transmit a signal to the speaker 1. This microphone can also be used to transfer audio signals to the communication device. The invention may use any or all of the following methods to indicate an incoming message. The speaker 1 will transmit an audio alert produced by the synthesizer 21 or be used to amplify the audio signal of the communication device. The speaker volume will be regulated by a controller 3 on the invention. A device to produce a ringer tone 9 will be connected to a timer 8 which will be used to control the repetition of the signal which was selected to indicate a message present. A display 2 can be used to indicate a message is present and will produce a visual signal generated from the invention by the audio, video, graphic control unit 18, if the visual signal from the communication device is not selected. A signal light 6 will also be used to indicated a message was received by the communication device. An on/off switch 19 will be on the invention to power the invention on or off. With respect to the above description then, it is to realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Given the speed at which semiconductor, electronics and software technology is progressing, the preceding is a description of the preferred embodiment of my inventive system which I contemplate will be implemented with the most technical and cost effective technology available at the time it is used for a particular application. Further, since numerous modifications and changes will readily occur to those skilled in the art, it is not desired to limit the invention to the exact construction and operation shown and described, and accordingly, all suitable modifications and equivalents may be resorted to falling within the scope of the invention.

1. A device to notify of messages to a wireless communication device by amplification of the notification signal of the communication device, comprising of a audio signal, visual signal, or a display screen, comprising:
an alerting device;
a microphone to capture the audio notification signal of the communication device and also the voice of the user;
a speaker for producing an alerting sound or message from the communication device;
a light to indicate a message is captured by the communication device;
the invention will attach to the communication device by means of plug, pin or wire, contact connection, optical connection or low-power signal connection or other methods or a combination of any methods;
the volume and frequency of the audio signal produced by the invention may be adjustable;
the attachment system between the communication device and the invention can be unique to each brand and/or model of communication device;
a display.

2. A power source to charge the internal battery of the communication device or power the communication device or invention an interface to which the communication device is attached, comprising:
a light to indicate attachment of the communication device to the alerting device;
a light to indicate the invention has power;
the invention can be powered by AC current, DC current, or battery;
a power connection on the invention for connection with an outside power source;
a transformer in invention for reduction said outside power source to provide the appropriate current to power or charge the communication device;
a system to terminate charging of the batteries of the communication device when said device is fully charged if the communication device has batteries;
a self contained power source for the invention which can power the invention when it is not connected to an external power source
